(19) United States
(12) Patent Application Publication
(10) Pub. No.: US 2003/0173302 A1
(43) Pub. Date: Sep. 18, 2003

(54) Method of controlling deposit formation in aqueous systems

(76) Inventors: Kun Xiong, Naperville, IL (US); Mingli Wei, Naperville, IL (US)

Correspondence Address: Kelly L. Cummings, Patent & Licensing Department, Ondeo Nalco Company, Ondeo Nalco Center, Naperville, IL, 60563-1198, US

(21) Appl. No.: 10/097,519

(22) Filed: Mar. 13, 2002

(51) Int. Cl. C02F 1/00

(52) U.S. Cl. 210/698

(57) ABSTRACT

Deposit formation is controlled in aqueous systems through the addition of at least one fatty amine surfactant.

### FIELD OF THE INVENTION

This invention relates generally to the field of deposit control and, more particularly, to a method of controlling deposit formation in aqueous systems.

### BACKGROUND OF THE INVENTION

Deposit formation on surfaces has always been problematic in aqueous systems, such as cooling tower waters and air washers, because it can adversely affect heat transfer efficiency and fluid frictional resistance, thereby subsequently reducing production rates. Deposit formation is also a problem in pulp and paper mill systems because the growth of microorganisms (as well as the accumulation of other materials such as fiber, starch, clay and calcium carbonate) in paper machine fluids can adversely affect finished paper products, thereby requiring the paper machine to be shut down, resulting in the loss of productivity brought on by the down time of the machine. Furthermore, deposits containing microorganisms can cause corrosion. The term “deposits” as used herein can be physical, chemical and/or biological in nature. Examples of deposits include biofilm and scale.

Some microorganisms attach to inert surfaces forming aggregates with a complex matrix consisting of extracellular polymeric substances (EPS). This consortium of attached microorganisms and the associated EPS is commonly referred to as a biofilm. The presence of biofilm in aqueous systems cannot be totally eliminated, even with the excessive use of chemical biocides. The most common way to control biofilm formation is through the application of toxic chemical biocides such as chlorine, bromine, isothiazolones, glutaraldehyde or other antimicrobials. These biocides are added in an attempt to kill both planktonic and sessile microorganisms. However, biocides have difficulty penetrating biofilms and removing them from surfaces. Although excessive biocide dosages may be able to control biofilm formation, such use is costly and the presence of biocides in effluent waters is usually environmentally unacceptable.

Accordingly, it would be desirable to provide a method of controlling deposit formation in aqueous systems which utilizes a low-cost, non-biocidal substance.

### SUMMARY OF THE INVENTION

The method of the invention calls for adding one or more fatty amine surfactants to an aqueous system. The addition of fatty amine surfactants efficiently and effectively controls deposit formation in aqueous systems. Moreover, the inventive method is economically appealing and environmentally acceptable because fatty amine surfactants are low in cost and non-biocidal.

### DETAILED DESCRIPTION OF THE INVENTION

The present invention is directed to a method of controlling deposit formation in aqueous systems. In accordance with this invention, one or more fatty amine surfactants are added to the aqueous system.

As used herein, “controlling deposit formation” includes the inhibition, reduction and removal of deposits from surfaces. The term “fatty amine surfactants” is defined as a group of surface active agents that have hydrophilic heads and hydrophobic tails of linear, branched or cyclic hydrocarbons.

The fatty amine surfactants that may be used in the practice of the invention include, but are not limited to, ethoxylated fatty amines, ethoxylated fatty amine oxides, ethoxylated fatty diamines, propoxylate fatty amines, fatty amines and polyamines, as well as mixtures thereof. The preferred fatty amine surfactants are ethoxylated fatty amines. Ethoxylated tallow amines and ethoxylated coco amines having 1 to 10 ethylene oxide (EO) units are the most preferred fatty amine surfactants. Those skilled in the art will recognize that the fatty amine surfactants of the present invention could also result from the enzymatic or chemical reaction of starting materials, such as fatty acids, amines and polymers with similar structures.

The fatty amine surfactants can be added to the aqueous system by any conventional method at a concentration which effectively controls deposit formation. It is preferred that the amount of fatty amine surfactant which is added to the aqueous system be in the range of about 0.1 ppm to about 10,000 ppm. More preferably, the amount of fatty amine surfactant is from about 0.1 ppm to about 100 ppm, with about 0.1 ppm to about 10 ppm being most preferred.

The aqueous systems to which the fatty amine surfactants may be added to control deposit formation include cooling waters; food, beverage and industrial process waters; pulp and paper mill systems; brewery pasteurizes, sweetwater systems; air washer systems; oil field drilling fluids and muds; petroleum recovery processes; industrial lubricants; cutting fluids; heat transfer systems; gas scrubber systems; latex systems; clay and pigment systems; decorative fountains; water intake pipes; ballast water tanks; and ship reservoirs, among others.

### EXAMPLES

The following examples are intended to be illustrative of the present invention and to teach one of ordinary skill how to make and use the invention. These examples are not intended to limit the invention or its protection in any way.

### Example 1

A multi-well tissue culture plate test was conducted to demonstrate the ability of fatty amine surfactants to control biofilms. Sphaerotilus natans is a filamentous, slime-forming bacterium common to paper mills and fresh waters. Therefore, this organism was used as the test isolate (S. natans ATCC 15291). The chemicals listed in Table 1 were applied to the test medium to prevent the attachment of microorganisms to test surfaces.

The test isolate was grown in a nutrient medium (ATCC 1103), which was modified to promote biofilm formation. The inoculum was harvested and aliquots were frozen and stored at −70° C. until needed. Fifty mL of sterile medium in an 8-oz flush glass jar were inolculated with 1 mL of the −70° C. inoculum stock and incubated for 30 hours on an orbital shaker at 200 rmp and 30° C. This culture served as a start culture for all treated media with a 0.6% reinoculation rate. 4 mL of inoculated media were distributed into the wells of a sterile 12-well tissue culture plate and treated with the chemicals listed in Table 1 by serial dilution. At least 3 duplicates were employed for each treatment. The plates were then incubated at 32° C. on an orbital shaker at 120 rpm for 40 hours. Biofilms were detected by staining with 5 mL of either 0.1% crystal violet or 0.03% 2-(4-iodophenyl)-3-(4-nitrophenyl)-5-phenyltetrazolium chloride for 10 minutes. The effectiveness was determined by the chemical concentration at which there was no biofilm formation on the surface of the walls of the well.

The results of the treatments are shown below in Table 1. The data illustrates the average effective concentration for 100% biofilm inhibition. By comparing the concentration of each chemical, their efficacy against biofilm formation can be compared. As the results in Table 1 clearly show, the ethoxylated fatty amine is much more efficient against biofilm formation than the other chemicals tested.

TABLE 1

| | Effective |
|---|---|
| Chemical | Concentration (ppm) |
| Lignosulfonate | >200 |
| Cinnamon Oil | 90.0 |
| Ethylene Oxide/Propylene Oxide Copolymer | 20.0 |
| (80:20, 2750 dalton) | |
| Rhodameen ® PN-430 Ethoxylated fatty amine* | 0.8 |

*Available from Rhodia Inc. of Cranbury, N.J.

### Example 2

Rhodameen®PN-430 ethoxylated fatty amine was used for deposit control in a dynamic process water system of a paper machine. Biofilm formation is one of the primary causes of deposit formation in papermaking systems. The ethoxylated fatty amine was fed in two separated channels on the Ondeo Nalco 3D Onsite Simulation System (3D System). The 3D System uses the process water from a papermaking system as its testing water source. The current configuration of the 3D System includes 3 identical channels equipped with many sensors in each channel, such as the Ondeo Nalco Optical Fouling Monitor (OFM), pH, oxidization and reduction potential (ORP), and temperature sensors, controlled sampling pumps, and chemical feeding pumps. One channel can be used as a control to monitor system parameters, while the other two channels can be used as testing channels for efficacy and program tests.

Table 2 below shows the effectiveness of the inventive method. The higher the OFM index, the more fouling that occurred in that channel. The data shows that at continuous feeding of 0.62 ppm active ingredient (a.i.) or slug feeding at 2.5 ppm a.i., at 3:5 minutes (on:off), the ethoxylated fatty amine controlled the deposit formation while the untreated channel (control) was totally fouled during the testing period.

TABLE 2

| | Fouling Index (U) | | |
|---|---|---|---|
| Time (hr) | Control | Program 1^{a} | Program 2^{b} |
| 0 | 27.0 | 23.2 | 48.5 |
| 2 | 33.7 | 23.0 | 53.2 |
| 4 | 2.8 | 0.9 | 27.6 |
| 6 | 33.6 | 23.1 | 51.9 |
| 8 | 93.6 | 27.2 | 59.2 |
| 10 | 126.9 | 27.3 | 60.9 |
| 12 | 154.1 | 28.0 | 61.1 |
| 14 | 166.7 | 25.7 | 59.6 |
| 16 | 166.7^{c} | 22.1 | 55.6 |
| 18 | 166.7 | 23.1 | 56.5 |
| 20 | 166.7 | 19.5 | 52.5 |
| 22 | 166.7 | 22.7 | 57.9 |
| 24 | 166.7 | 30.4 | 69.7 |

^{a}Continuous Feed at 0.62 ppm
^{b}Slug Feed at 2.5 ppm for 3:5 min (on:off)
^{c}Over the maximum limit

While the present invention is described above in connection with preferred or illustrative embodiments, these embodiments are not intended to be exhaustive or limiting of the invention. Rather, the invention is intended to cover all alternatives, modifications and equivalents included within its spirit and scope, as defined by the appended claims.

What is claimed is:

1. A method of controlling deposit formation in aqueous systems comprising the step of adding thereto an effective deposit controlling amount of at least one fatty amine surfactant selected from the group consisting of ethoxylated fatty amines, ethoxylated fatty amine oxides, ethoxylated fatty diamines, propoxylate fatty amines, fatty amines, polyamines and mixtures thereof.

2. The method of claim 1 wherein the fatty amine surfactant is an ethoxylated fatty amine.

3. The method of claim 1 wherein the fatty amine surfactant is selected from the group consisting of ethoxylated tallow amines and ethoxylated coco amines having 1 to 10 ethylene oxide units.

4. The method of claim 1 wherein the fatty amine surfactant is added to the aqueous system in an amount from about 0. 1 ppm to about 10,000 ppm.

5. The method of claim 1 wherein the fatty amine surfactant is added to the aqueous system in an amount from about 0.1 ppm to about 100 ppm.

6. The method of claim 1 wherein the fatty amine surfactant is added to the aqueous system in an amount from about 0.1 to about 100 ppm.

7. The method of claim 1 wherein the aqueous systems are selected from the group consisting of cooling waters; food, beverage and industrial process waters; pulp and paper mill systems; brewery pasteurizers; sweetwater systems; air washer systems; oil field drilling fluids and muds; petroleum recovery processes; industrial lubricants; cutting fluids; heat transfer systems; gas scrubber systems; latex systems; clay and pigment systems; decorative fountains; water intake pipes; ballast water tanks; and ship reservoirs.
